(19) United States
(12) Patent Application Publication
(10) Pub. No.: US 2006/0256561 A1
(43) Pub. Date: Nov. 16, 2006

(54) Light socket adapter and adjustable light fixture

(76) Inventor: Prince Albert Smith, Miramar, FL (US)

Correspondence Address: JOSEPH S. BECKMAN, 3104 SW WIMBELDON TERRACE, PALM CITY, FL, 34990, US

(21) Appl. No.: 11/127,739

(22) Filed: May 12, 2005

(51) Int. Cl. F21V 19/02

(52) U.S. Cl. 362/287; 362/418; 362/267

(57) ABSTRACT

A novel light socket adapter with flexible light extensions and an adjustable wall-mounted light fixture for improved multi-directional lighting.

### FIELD OF THE INVENTION

This invention relates to the design and construction of a novel light socket adapter with flexible light extensions and an adjustable wall-mounted light fixture for improved multi-directional lighting.

### BACKGROUND OF THE INVENTION

Adjustable wall-mounted light fixtures exist in various forms and are well known in the prior art. Conventionally and ubiquitously, adjustable wall-mounted light fixtures have incorporated elaborate mountings and/or were limited in their degree of adjustable directions.

Conversely, A light socket adapter with flexible light extensions is not well known in the prior art. While there are flexible light fixtures, they typically are incorporated into a self-contained unit with a base or mounting unit. The prior art does not disclose an invention wherein flexible light extensions can replace light bulbs in already existing light sockets.

Prior art disclosed in U.S. Pat. No. 3,962,678 issued to Kurokawa entitled “Lighting Apparatus,” attempts to address the use of a flexible lighting fixture for improved multi-directional lighting. However, the Kurokawa apparatus is specifically designed for use as a stand-type lamp for use on desks, tables, and the like. This type of apparatus is not mountable as a wall fixture and has externally visible wiring, which connects to a power source. Moreover, the apparatus incorporates a light assembly comprising a socket; a light bulb; a shade; and a stand. The disadvantage here is that this apparatus is one self-contained unit. The apparatus is not capable of being adapted into the socket of an existing light fixture.

Prior art disclosed in U.S. Pat. No. 3,305,681 issued to Green entitled “Light Fixture With Adjustable Beam Director,” attempts to address the use of a light fixture that may be mounted to a ceiling, floor, or sidewall and that which is capable of being adjusted in multiple directions. The invention utilizes a light housing unit that is mounted within a support ring that rotates around an axis and is connected to a hanging stem. The light housing unit is capable of sliding within the ring. The drawback to this invention is that in order to obtain full directional control the support ring has to be inclined to a certain angle and the light housing unit retained thereto. Further, it is the combination of two elements—both the movement of the support ring and the movement of the light housing unit that provides the full directional control. Another drawback is that the hanging stem has to protrude down from the mounting in order to achieve the full directional control. In the above-described embodiment, the light housing unit itself may not mount directly to the ceiling, wall, or floor and still maintain its multiplicity of directions. Although the invention does provide for recessed fixtures, the recessed fixture mountings are complex and are incapable of being adjusted to a full horizontal position. Moreover, in all embodiments disclosed in this invention, the use of multiple parts and rigid materials to accomplish the multiple directional features does not allow the most flexible, easy, and pliable movement.

Clearly there is a need for both an adjustable wall-mounted light fixture that may be easily mounted directly to a wall or ceiling without additional space to allow for a full range of movement, and a light socket adapter with flexible light extensions that may replace light bulbs in existing light fixtures.

### SUMMARY OF THE INVENTION

There have been a number of adjustable wall-mounted light fixtures in the prior art. The inventive structure presents a number of advantages over the prior art. First, the invention is simple to form. The light fixture comprises a mounting device, at least one flexible extension, and at least one light bulb. The light fixture may have more than one flexible extension, which is useful for simultaneously projecting light in multiple and separate directions with the use of only one fixture, or for providing additional lighting to a single area. The light extension may be made of plastic, metal or any other suitable structural material, and appropriate seals may be used to make the fixture water tight for outdoor use.

The flexible light extensions are very pliable, and may come in varying lengths. These features provide the capability of bending the light fixtures to illuminate areas that may otherwise be difficult to illuminate without adding additional light fixtures. For example, a light fixture may be installed by the side of a garage to illuminate the front of the house, and one light extension may be bent around the corner to provide lighting to a walkway up to the front door of a house. The direction of the light extensions may also be easily changed by simply re-bending the extensions to illuminate another area. The light extensions maintain their position without the need-for retaining means, which eliminates the necessity of having to take apart the fixture, reposition, and then re-secure the fixture, as disclosed in the prior art.

The flexible light extensions may also be telescopic. This feature allows the light extensions to be fully extended when in use, and then retract to free up the additional space utilized by the lengthy extensions.

A light socket adapter incorporating the flexible light extensions, as described above, is not well known in the prior art and provides a number of advantages over traditional adjustable light fixtures. The light socket adapter may replace light bulbs in existing light fixtures. This eliminates the necessity of replacing and re-wiring existing light fixtures, and greatly reduces the costs associated with replacing entire light fixtures. Further, the light socket adapter is readily moveable from fixture to fixture. The light socket adapter can easily transform a regular table lamp into a reading lamp by replacing the existing light bulb with the adapter. The reader may then position the extension to directly illuminate the page he or she is reading. Moreover, if the reader chose the telescopic extension, he or she could retract the extension into the lamp when finished reading and leave the adapter in the lamp in the retracted position to illuminate the area like a regular light bulb. The adapter may also be used under fans and on tracks for better spot lighting.

Although the invention has been described with regard to certain preferred embodiments which constitute the best mode presently known to the inventor, it should be understood that changes and modifications that would be obvious to one having the ordinary skill in this art may be made without deviating from the scope of the invention.

### BRIEF DESCRIPTION OF THE DRAWINGS

FIG. 1 is a view of the light socket adapter with flexible, telescopic light fixtures according to the embodiments described herein.

FIG. 2 is a view of the light socket adapter with a flexible, non-telescopic light fixture according to the embodiments described herein.

FIG. 3 is a view of the wall-mounted adjustable light fixture according to the embodiments described herein.

### DESCRIPTION OF THE INVENTION

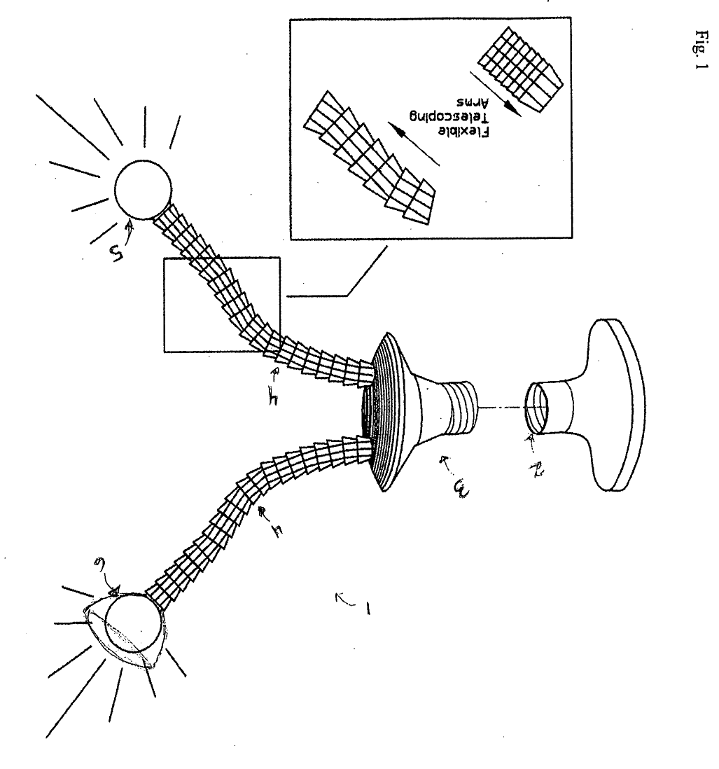

Shown in FIG. 1 is a flexible, telescopic light fixture (1), which comprises an existing light socket (2) that receives the light fixture adapter (3). The light fixture adapter (3) may have one or multiple flexible, telescopic light extensions (4) with various shaped and sized light bulbs (5). The light bulbs may be covered partially or completely with shades (6) to protect the light bulb and focus the light.

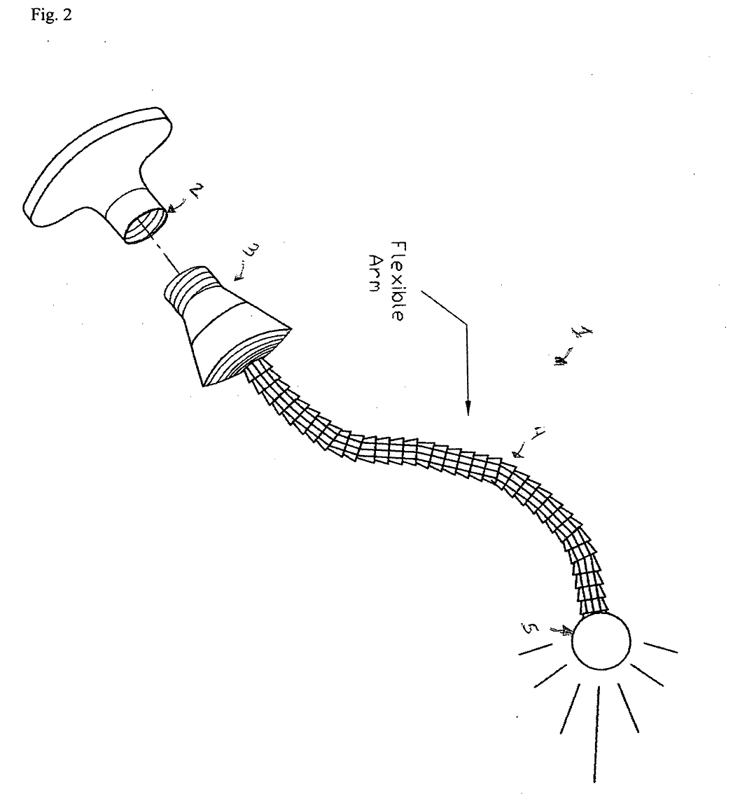

The light extensions (4) may be flexible and telescopic as shown in FIG. 1 to allow the light extensions (4) to be bent toward a certain direction and extended or retracted for space considerations. The telescopic feature may be particularly useful when using the adapter in existing lamp light sockets. This feature would allow the extensions to be pulled out when needed and then retracted into the lamp to provide normal lighting. Conversely, the light extensions (4) may be flexible only, as shown in FIG. 2.

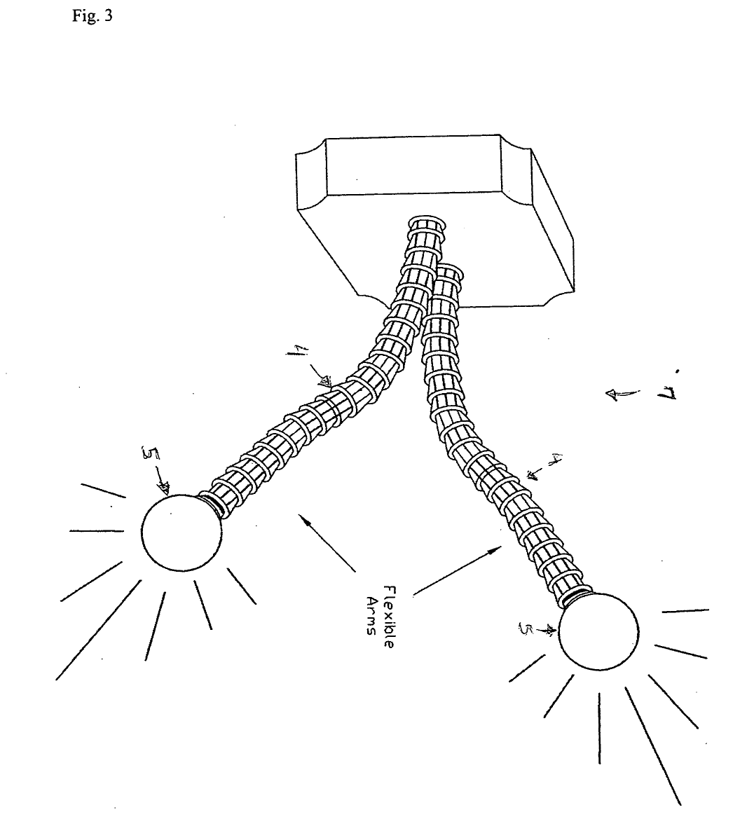

In another embodiment, as shown in FIG. 3, the flexible light fixture is a complete wall-mounted unit (7). This embodiment eliminated the adapter feature and may not be used in existing light sockets. In this embodiment, the light extensions (4) may also be either flexible or flexible and telescopic.

What is claimed is:

1. A light socket adapter with flexible light extensions for improved multi-directional lighting, said unit comprising:
An adapter;
At least one flexible light extension; and
At least one light bulb.

2. A light socket adapter as described in claim 1 wherein said flexible light extensions are made of metal or plastic.

3. A light socket adapter as described in claim 1 wherein said flexible light extensions vary in length and dimension.

4. A light socket adapter as described in claim 1 wherein said flexible light extensions are telescopic.

5. A light socket adapter as described in claim 1 wherein seals are utilized to make said unit watertight for outdoor use.

6. A light socket adapter as described in claim 1 wherein a shade is utilized to partially cover the light bulb.

7. A light socket adapter as described in claim 1 wherein a shade is utilized to completely cover the light bulb.

8. An adjustable wall-mounted light fixture for improved multi-directional lighting, said unit comprising:
A mounting device;
At least one flexible light extension; and
At least one light bulb.

9. An adjustable wall-mounted light fixture as described in claim 8 wherein said flexible light extensions are made of metal or plastic.

10. An adjustable wall-mounted light fixture as described in claim 8 wherein said flexible light extensions vary in length and dimension.

11. An adjustable wall-mounted light fixture as described in claim 8 wherein said flexible light extensions are telescopic.

12. An adjustable wall-mounted light fixture as described in claim 8 wherein seals are utilized to make said unit watertight for outdoor use.

13. An adjustable wall-mounted light fixture as described in claim 8 wherein a shade is utilized to partially cover the light bulb.

14. An adjustable wall-mounted light fixture as described in claim 8 wherein a shade is utilized to completely cover the light bulb.
